(19) United States
(12) Patent Application Publication
(10) Pub. No.: US 2002/0007290 A1
(43) Pub. Date: Jan. 17, 2002

(54) On-line system for service provisioning and reimbursement in health systems

(76) Inventor: Joshua L. Gottlieb, Chagrin Falls, OH (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 09/854,063

(22) Filed: May 11, 2001

Related U.S. Application Data
(60) Provisional application No. 60/204,151, filed on May 15, 2000.

(51) Int. Cl. G06F 17/60

(52) U.S. Cl. 705/4

(57) ABSTRACT

A system for on-line provisioning and payment or reimbursement of durable and disposable medical equipment, home health care and home medical equipment. The system includes a distributed electronic cataloging, order taking, submission, shipping and payment system interacting under direction of an established plan formulary. Eligibility for the equipment and services is established on the front end of order processing. The system allows for differentiation as to which items, products or services are directed to a consumer, and which require a local provider.

This application claims priority under 35 U.S.C. § 119(e) from U.S. Provisional Patent application Serial No. 60/204,151 entitled “Online System And Method For Service Provisioning And Reimbursement In Health Systems” filed May 15, 2000.

### BACKGROUND OF THE INVENTION

1. Technical Field of the Invention

This invention is related to on-line provisioning and reimbursement associated with durable and disposable medical equipment and services.

2. Background of the Art

Existing Durable and Disposable Medical Equipment and Home Health Care/Home Medical Equipment systems (designated collectively as “DME”) employed in the current health care system suffer from many inefficiencies and flaws that cause substantial expense and delay in processing requests for equipment and claims for reimbursement. However, it can be appreciated that the subject system has broader implications, particularly in connection with the administration of distribution, delivery, and reimbursement areas, particularly in an on-line arena.

There has been increasing use of automation and information processing in connection with administration of health care. The first wave of improvements to these systems has been in connection with the administration of health care services, including reimbursement for physician and hospital costs. A next wave of improvements arose in connection with prescription drug management and reimbursement. While such improvements have greatly aided the efficiency of health care administration, they do not address a significant, and growing expense of health care. The average age of U.S. citizens continues to rise as the baby-boomer generation matures. With this increase of age comes a corresponding increase in the need for DME. The current system has many drawbacks and inefficiencies which lead to a failure in optimal patient care, and increased costs to all parties concerned.

The existing revenues in the highly fragmented sector of health care associated with DME are estimated to range from $40-$60 billion. Some of the current participants in this sector from the supply-chain side include manufacturers, dealers (typified as manufacturer representatives) who also generally are providers (accredited to measure/install/sell items such as custom wheelchairs, respiratory equipment, beds, etc.), Group Purchasing Organizations (“GPOs”), Provider Network Managers, Distribution Companies, and others. These various entities in the supply chain are highly competitive, rarely cooperative, and have a high degree of mistrust toward one another. As a result, many of the participants engage in collateral services that may not benefit from their core expertise, but nonetheless, allow them to usurp and/or maintain control of a share of the health care market, be it real or perceived. Providing such non-core services as a part of their business is costly and drives increased expenses and/or lower profits to the health care system.

The parties who prescribe/make the purchasing decisions for DME services are generally entities such as the patient (such as diabetics), physician, facility (hospital or clinic), or Case Manager (especially in the case of Worker's Compensation and automobile accident claims). This segment of the purchasing pool (except for the patients) is comprised of parties to whom the dealers/DME providers market their goods and services. That is, they sell (or the manufacturers' sell) to physicians, GPOs, distribution companies (e.g., McKesson, Cardinal, Bergen Brunswig), hospitals, hospital chains, etc. The large number of prescribers of DME create a very high cost to market, comparable to the costs associated with the pharmaceutical distribution system.

The parties who ultimately pay the bill for DME products, occasionally the patient, and primarily the Health Care Payor (“Payor”) (e.g., private insurance carriers, HMOs, Auto Insurers, Workers' Compensation carriers, Medicaid and Medicare organizations), have little influence over what is prescribed, the payment and reimbursement rates, or any post-delivery information. In some cases, a Health Care Payor may have some generalizes pricing agreements or protocols, but little exists today on Payor systems to assist in the enforcement of such protocols or pricing agreements.

In pharmacies today, each Payor has one or more Pharmacy Benefits Management (“PBM”) relationships. Each PBM works with the Payor to establish the network of participating pharmacies, pricing structures, preferred products and procedures, as well as co-pay and reimbursement rates for a plan (or plans) that the Payor offers to its patients/members. The PBM contracts with a company called a “switch adjudicator,” which is a company that manages each transaction electronically. For example, as a prescription is ordered, the pharmacist—either via telephone or via computer—is able to determine patient eligibility and the related Plan Formulary. In turn, the pharmacist may ask if the patient wants a “brand” or “generic” drug, then fills the prescription and collects whatever costs the system directs. The switch adjudicator (on behalf of the PBM) or the PBM (having received data on cumulative transactions from the switch adjudicator (or switch adjudicators, if using more than one)), aggregates the claims data, submits a bill to the health care Payor, collects funds, and disburses to the participating pharmacies their portion of the price that was negotiated. Included in the price (generally) is an ingredient cost, a dispensing fee, and in some cases, an administration fee. The PBM will mark up one or more of these items in its contract with the Payor to make its gross profits. The PBM may also receive rebates from Drug Manufacturers depending upon the threshold of sales (perhaps the volume, or the volume as a function of market share). The PBM may also sell the data to a third party for research purposes, although significant restrictions apply to maintain patient confidentiality.

What is needed is a turn-key on-line system which provides a complete end-to-end solution to the DME needs of existing health care organizations.

### SUMMARY OF THE INVENTION

The invention disclosed and claimed herein, in one aspect thereof, comprises a system for on-line provisioning and payment or reimbursement of durable and disposable medical equipment, home health care and home medical equipment. The system includes a distributed electronic cataloging, order taking, submission, shipping and payment system interacting under direction of an established plan formulary. Eligibility for the equipment is established on the front end of order processing. The system allows for differentiation as to which items, products or services are directed to a consumer, and which require a local provider.

### BRIEF DESCRIPTION OF THE DRAWINGS

For a more complete understanding of the present invention and the advantages thereof, reference is now made to the following description taken in conjunction with the accompanying drawings in which:

FIG. 1 illustrates a block diagram of the disclosed system and general relationships established therein, in accordance with a disclosed embodiment;

FIG. 2 illustrates a flow chart of the method for basic implementation of the disclosed on-line health system;

FIG. 3 illustrates a flow chart for order processing; and

FIG. 4 illustrates a system block diagram of the disclosed provisioning and reimbursement system.

### DETAILED DESCRIPTION OF THE INVENTION

Disclosed herein is a turn-key on-line “linking” architecture for an improved Durable and Disposable Medical Equipment and Home Health Care/Home Medical Equipment (designated collectively as “DME”) system incorporating remote or distributed information processing, preferably over a global communication network (“GCN”) (e.g., the Internet) having both e-commerce and electronic communication (e.g., e-mail) capability.

The system is based upon a premise that a Health Care Payor (“Payor”) (e.g., private insurance carriers, HMOs, Auto Insurers, Workers' Compensation carriers, Medicaid and Medicare organizations, etc.) is the party most competent to make a determination on what it will pay for, how much it will pay, what products and product pricing are acceptable, and control the entire supply chain, i.e., an end-to-end supply chain model from manufacturing to patient. The Payor perceives a single outsourcing solution which provides significantly reduced costs for claims processing, and accordingly, reduced staffing and costs related to such claims processing. Furthermore, the Payor is provided the capability of data mining information of interest during the transaction or after-the-fact. Information can be retrieved on any and all aspects of a single claim and/or group of claims on a real-time basis. In addition, claims data of a Payor can be reviewed from a historical perspective, whether it includes just DME or all claims. The data mining of historical data can also be utilized to extract the relevant information about DME, and compare to expectations, beliefs and contracts (if any) of a Payor.

In the disclosed supply-chain model, two core relationships are established; one with a distribution company, and another with a Provider Network Manager (“PNM”). The PNM oversees the network of local providers selected to provide the product or services for the patients. The PNM performs the due diligence (for example, assessing the local provider's qualifications for installation and servicing of various categories of DME) on candidate local providers seeking to subscribe as providers of the front-end services of the plan formularies, and negotiates a fee-for-services agreement with the local providers. The PNM assigns a provider to an order based upon the qualifications of the local provider as to the particular product or service requested by a patient in a geographic area. A first step is the provisioning of a Plan Formulary (or Formularies) with the Payor. Today, pricing and protocol are sometimes set at a carrier level. The subject system provides for a fill Plan Formulary Management system, which in the past, has been deficient.

The subject development provides at least one of a DBM (DME Benefits Management) system and an HBM (Home Health Care Benefits Management) system. The disclosed system teaches a DME system which realizes some of the benefits heretofore associated with a Pharmacy Benefits Management (“PBM”) system, but goes well beyond such a conventional system to include, for example, the PNM, local providers, manufacturers, and Distribution/Logistics Partner (“DLP”).

In pharmacy networks today, each Payor has one or more PBM relationships. Each PBM works with the Payor to establish the network of participating pharmacies, pricing structures, preferred products and procedures, as well as co-pay and reimbursement rates for one or more plans that the Payor offers to its patients/members. When a patient or customer seeks a prescription from a pharmacist, a health insurance card is submitted by the customer. The membership plan number is obtained from the card and entered into the pharmacy computer system. The card information is then forwarded to the switch adjudicator which has a database system that retains eligibility files of patients and products, or has access into such files from participating insurance carrier companies, and the pharmacy plan details. Therefore, patient eligibility and drug eligibility (e.g., generic) are automatically determined utilizing this system. There are other rules which the PBM may turn on or off to provide filtering criteria, e.g., the purchasing history of the patient, whether the prescribed drug will introduce a dangerous combination with a drug that the patient may already have received, the frequency of issued prescriptions, etc. This filtering aspect is utilized in the disclosed DME system not only for drugs, but goes well beyond that to include orders for products or services which may be prescribed and ordered for the patient, the tracking and delivery of such products and services throughout the ordering and delivery process, and the billing and distribution of fees to all participants of such DME equipment. Further details are provided hereinbelow.

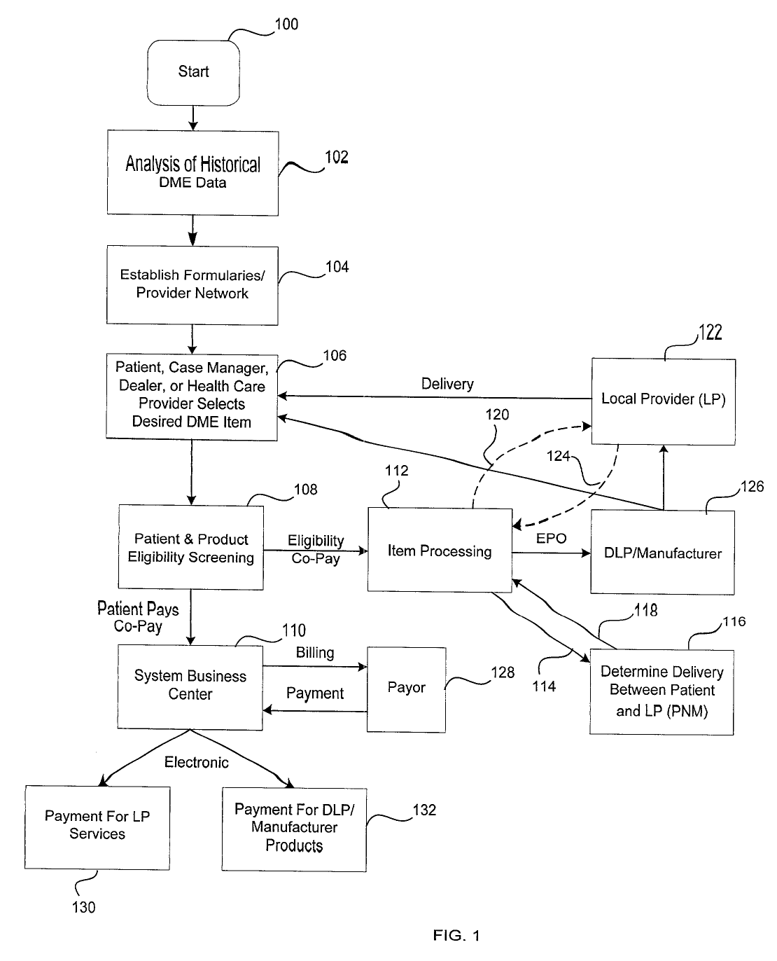

Referring now to FIG. 1, there is illustrated a block diagram of the disclosed system and general relationships established therein, in accordance with a disclosed embodiment. Entry into the system begins at a Start block 100 and flows to an analysis block 102 where historical data related to the subscribing entity is reviewed as a prelude to preparation of a one or more plan formularies which the subscribing entity wishes to automate utilizing the disclosed novel linking system. Flow is then to block 104 where the plan formulary is developed and the network of providers identified to support the plan formulary. As indicated hereinabove, it may be necessary to identify different providers for each plan formulary, or a single provider for all formularies. This, of course, depends upon the type and variety of products and services which the subscribing entity provides. With the plan formulary and network of providers now in place, order processing can commence. In an item-selection block 106, any one or more of several entities select one or more DME items, whether the item be a product, a service, or both. The ordering entities include, for example, the patient, Case Manager (“CM”), Dealer, and Health Care Provider. The disclosed architecture is not limited to these entities for ordering products or services, but is flexible to accommodate any entity which may be programmed into the linking system for such a function. The order is then processed electronically through the GCN.

Once an order is received for a patient, eligibility must be established for the ordered item. In a block 108, eligibility of the item for the particular patient is determined, and also eligibility of the item under the corresponding plan formulary. When the item is authorized, the patient pays the plan co-pay amount, if any, to the system business center (“SBC”), associated with a block 110. The plan co-pay amount can be made by a variety of payment mechanisms, however, in this particular embodiment, payment by credit card is preferred. The credit card payment can be made by the patient utilizing the telephone to call-in the appropriate credit card account information to personnel at the SBC, or alternatively, by logging in to a secure website disposed on the GCN such that payment is made electronically via the secure website. Note that other conventional Internet-based and switched-circuit payment mechanisms may be implemented in accordance with the architecture of the disclosed linking system.

The SBC receives the co-pay amount, and stores such transactional information. Note that fulfillment of the order can be based upon several criteria, for example, the patient can be denied the order until the proper co-payment has been received, or the order can be initiated as soon as eligibility is established. The linking system can be programmed to operate under a number of criteria in accordance with, for example, the particular subscriber products/services, the patient, and/or plan formulary.

Once eligibility and co-pay are completed, flow is to an order processing block 112 where the item ordering process is initiated. It can be appreciated that a particular order may require pre-order information from or about the patient. For example, if the order was a wheelchair, prior to placing an electronic purchase order (“EPO”) for the chair, the local provider may need to be identified who can accommodate the order, the order accepted by the local provider, and personnel dispatched to the patient location to obtain measurements in order to select the correct wheelchair. In such a scenario, interaction is then across a path 114 to a block 116 to determine the type of delivery associated with the particular item ordered. In the case of the wheelchair, assembly is required, which indicates that it would be shipped to the local provider first, and not directly to the patient. However, it is then necessary to determine which local provider has the capability of fulfilling the requirements of the order. The PNM associated with block 116 determines which local providers can accommodate particular orders for a geographical area proximate to the patient. Once determined, information is passed from block 116 back to the order processing block 112 via a path 118. The order processing block 112 then communicates the order requirements across a path 120 to the selected local provider associated with a block 122. Continuing with the wheelchair example, the local provider may need to visit the patient to obtain additional patient information (e.g., patient measurements, etc.) prior to the order be processed. The pre-order patient information is returned to the order-processing block 112 across a communication path 124. (The item processing block 112 is considered part of the SBC block 110 such that when the local provider accepts an order, the acceptance transmitted back to the SBC block 110 and/or PNM block 116. Similarly, if pre-order patient measurements are required for the patient order, the patient measurement information is also transmitted back to the SBC block 110 and/or PNM block 116.) Note the communication paths 120 and 124 are denoted as dotted lines to indicate that this is an optional process dependent upon the type of order. For example, if the item ordered wag a drug, no preparatory action may be needed by the local provider. Therefore, the EPO is transmitted directly to the DLP from the SBC block 110 for immediate processing and delivery to the patient.

The disclosed system supports competition in the marketplace by providing the distribution company (or companies) the leverage to negotiate with manufacturers regarding directing business to them and having the ability to fairly accurately calculate and direct the business. This provides an overall cost savings to the patient/customer and health care entities with respect to conventional systems.

Like other costs in the disclosed health system chain, the marketing costs for manufacturing are virtually extracted. There is no incremental cost to add the disclosed business system. To the extent purchases are made through the subject system, no requirement for the manufacturer or distributor to determine the financial stability of the local provider is required, nor is there a need to nurture this manufacturer-distributor relationship. To the extent that the local provider is in the Network, it will not handle any funds except its own. This will also drive down a manufacturer's costs of managing its dealer network, billing for amounts owed, and competing for business.

As indicated hereinabove, once the pre-order patient information has been obtained and electronically formatted into the patient order, the EPO is processed at the SBC block 110 and electronically communicated to a DLP/Manufacturer block 126. The purchase order is transmitted electronically across the GCN to the one or more entities associated with DLP/Manufacturer block 126. For example, if the item order can be readily obtained from an inventory, it can be processed directly by the DLP to expedite selection of the appropriate method for acquiring the item and shipping it to the patient (associated with block 106) and/or local provider (associated with block 122). Alternatively, if the ordered item requires special ordering, the purchase order can be transmitted electronically to a selected manufacturer. The item is then either shipped directly to the patient, or indirectly to the patient through the local provider. The item from the manufacturer can also be coordinated for shipment to either the patient or local provider through the DLP, if desired. However, it should be understood that where GCN connectivity exists for the local provider 122, the local provider 122 provides all necessary input to the SBC 110 for order processing, and the SBC 110 contacts the DLP/Manufacturer. If the local provider 122 is not networked to the GCN, order acceptance and pre-order patient information is transmitted first to the PNM block 116, and from the PNM block 116 to the SBC block 110. By having the SBC 110 place the order, the disclosed system retains quality control on order placement, tracking, billing, collection, and remittance.

The SBC in block 110 is operable to store all information associated with the many transactions of the disclosed linking system. For example, the SBC accumulates products and services cost information for ultimate billing to the Payor (associated with a block 128). The Payor transmits the payments back to the SBC for distribution to the entities which have provided the products and services. It is preferable, for example, that the local provider be paid electronically, as indicated in a block 130. Similarly, it is preferable to transmit payments electronically to the DLP/Manufacturer, as associated with the payment system of a block 132. The systems used to facilitate such payment transactions can be via conventional electronic systems such as direct deposit via ACH (Automatic Clearing House service providers), other banking systems, Internet-based systems, etc.

Notably, communication between the various blocks and entities is preferably via the GCN. Such information includes, for example, personal medical information, personal credit information, corporate information, etc., all which needs to be properly secured from unauthorized access, and in some cases, in accordance with federal laws (e.g., HIPAA—The Health Insurance Portability and Accountability Act). Additionally, not all communication links to the illustrated block entities are shown. For example, with the advent of the Internet, it can be appreciated that most, if not all entities discussed hereinabove can be made operable to communicate over a packet-switched network (i.e., the GCN). The local provider can be connected via the GCN to the SBC of block 110 to facilitate fee payments for services rendered.

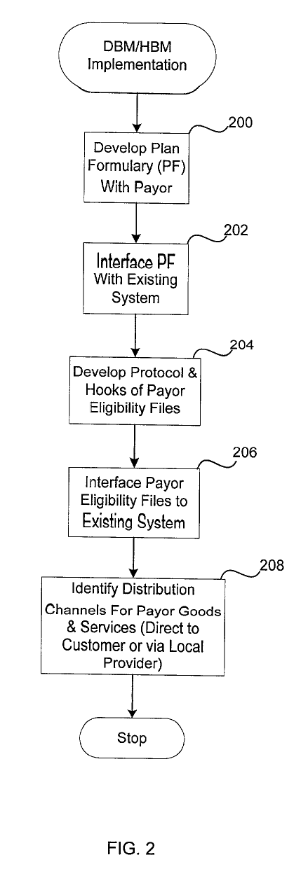

Referring now to FIG. 2, there is illustrated a flow chart of the method for basic implementation of the disclosed on-line health system. Flow begins at a function block 200 where a Plan Formulary is developed with the Payor in accordance with each of the Payor medical programs. Flow continues to a function block 202 where the one or more Plan Formularies are interfaced with the existing on-line system. This is primarily a software function. The Payor eligibility files then need to be made accessible to the on-line health system. Again, this is primarily a software function which institutes a Payor protocol and system “hooks” to accommodate connection in a specified manner to the Payor eligibility files, as indicated in a function block 204. The Payor eligibility files are then interfaced to the on-line health system using the protocol and hooks, as indicated in a function block 206, in order to establish front-end eligibility. Flow continues to a function block 208 to identify the appropriate distribution channel for the goods and/or services, i.e., direct to the customer, or via a local provider who then installs or delivers the goods and/or services. As an order is placed electronically, the on-line system directs the order from the SBC to the DLP or to the PNM. The order interface is then customized to allow for differentiation as to which items/products/services are direct to consumer, and which require a local provider (e.g., a walker versus a wheelchair).

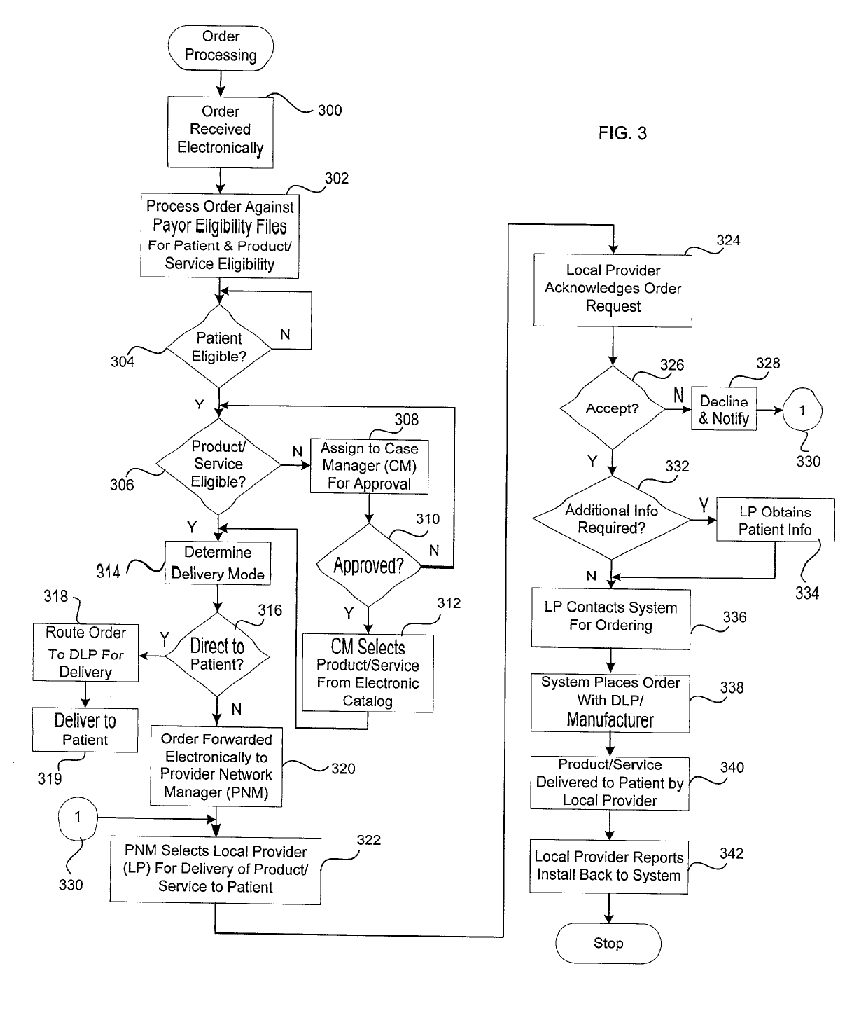

Referring now to FIG. 3, there is illustrated a flow chart for order processing. Flow begins at a function block 300 where an order is received electronically, e.g., via e-mail or a user interface suited for electronic order submission, such as HTML, DHTML, CGI, XML, etc. Flow continues to a function block 302 where the order is processed against the Payor eligibility files to determine if the ordered product/service can be authorized, and that the patient is eligible for such a product and/or service. Flow is to a decision block 304 to determine if the patient is eligible under the plan formulary. If not, flow is out the “N” path, and loops back to the input of decision block 304 to determine patient eligibility for the next order. Note that order processing does not necessarily occur in a single tasking mode such that a first order must be completely processed before processing commences on a second order. The system is a multi-tasking system to handle a large number of orders more efficiently in a substantially simultaneous operation.

If the patient is eligible, as determined against Payor eligibility files, flow is out the “Y” path of decision block 304 to a decision block 306 to determine the eligibility of the requested product and/or service. In some cases, the product or service ordered requires special review, which special review is provided by a Case Manager who may be an employee of the Payor, or even a third-party administrator acting on behalf of the Payor. For example, where the order exceeds a certain cost, or the order falls within other certain criteria, involvement by the Case Manager will be required to provide the necessary review prior to authorizing the order for processing. The Case Manager will then review the requirements for eligibility against the plan formulary. A more specific example is where a triggering event occurs from a patient has ordered two wheelchairs within a short period of time (e.g., one month). The patient may or may not be eligible for the second order in such a short period of time. In any case, the Case Manager reviews such triggering events to ensure compliance with the established Plan Formulary and eligibility requirements. Under such conditions where an order falls within certain triggering criteria, flow is out the “N” path of decision block 306 to a function block 308 where the order is referred to the Case Manager for closer review. This suitably occurs via phone or fax, but not typically systematically via computer without human intervention. Flow is then to a decision block 310 where the CM determines if the order is valid. If not approved, flow is out the “N” path back to the input of decision block 306 to determine if the next product/service is eligible. If the CM determines that the order is valid, flow is out the “Y” path of decision block 310 to a function block 312 where the CM selects the product/service from an electronic catalog to facilitate processing of the patient order. Flow is then to a function block 314 (which is also the “Y” path output of decision block 306, when a product/service is determined to be eligible for the particular patient) where the mode of delivery for the product/service is determined.

Flow continues to a decision block 316 to determine if delivery should be direct to the patient. For example, if the product was a drug, delivery can be direct to the patient, since any intervention by the local provider is not required. Flow is then out the “Y” path of decision block 316 to a function block 318 where the order is routed to the DLP for distribution to the patient, and delivered to the patient, as indicated in a function block 319. However, if the order is for a product that requires servicing, the local provider is required to be involved, and flow is out the “N” path to a function block 320 where the order is forwarded electronically to the PNM. Electronic communication can be via e-mail, or by utilizing telephone, facsimile, etc. The PNM in this particular embodiment is a trained individual. However, it can be appreciated that such a function can be provided in the form of one or more software modules which provide all of the desired options for handling a particular electronic order. Such electronic data transfer provides significant advantages in expediting and accounting such orders over more conventional transfers which utilize telephone and/or facsimile transmissions. Flow is then to a function block 322 where the PNM assigns the appropriate local provider who has the capability of processing and delivering the order, and who is in the geographic location of the patient designated to receive the order.

The local provider receives the order request and acknowledges to the PNM receipt thereof, as indicated in a function block 324. Flow is then to a decision block 326 where the local provider either accepts or declines the order. Once assigned, the local provider acknowledges the order utilizing the system (suitably via direct Internet/Intranet e-mail, or through a hand-held device using any suitable WAP (Wireless Access Protocol) or cellular technology, such as Bluetooth, 802.11, CDPD, and the like). If the order is declined, flow is out the “N” path to a function block 328 where the local provider declines the order and notifies the PNM accordingly. The local provider can decline the order for any number of reason, e.g., schedule does not permit, personnel incapable of providing or unavailable for providing the service, etc. (Note that the local providers are screened based upon credentials and location during the preparation phase of the plan formulary such that it is unlikely that a local provider who has been selected for a particular product or service by the PNM, will decline an order.) Flow is then along a path 330 to the input of function block 322 where the PNM can then select another local provider who can deliver the order.

On the other hand, if the local provider accepts the order, flow is out the “Y” path of decision block 326 to another decision block 332 to determine if additional patient information is required. If so, flow is out the “Y” path to a function block 334 where the local provider contacts the patient to obtain patient information suitable for completing the patient order. (For example, determining the patient's height and weight, and other information, in order for the manufacturer to configure a wheelchair properly.) The local provider reports the additional patient information back to the system, which, in turn, submits the order to the manufacturer or the DLP. (As indicated hereinabove, the local provider can communicate with the disclosed system via any number of conventional means, for example, wirelessly, a packet-switched network connection, etc.) The ordering operations to the manufacturer or the DLP are preferably performed via an e-Commerce transaction to expedite order processing. Flow is from function block 334 to the input of a function block 336 (which is also the “N” path output of decision block 332 when it is determined that additional patient information is not required) where the local provider contacts the disclosed system (i.e., the SBC or PNM, depending on the communication mode of the local provider) to input the patient information and to confirm ordering and delivery information for the product. Flow is then to a function block 338 where the SBC automatically places the patient order with either the DLP (where the product is an off-the-shelf product which can be obtained from inventory and shipped immediately) or the manufacturer (where the updated patient information requires the product to be manufactured, or ordered from the manufacturer). This operation is preferably performed via an e-Commerce transaction to expedite order processing. However, alternative communication methods such as telephone and/or facsimile may also be employed where the local provider is not operable to perform such an e-Commerce transaction. Flow is to a function block 340 where the product is then delivered to the local provider, and then to the patient after processing by the local provider. It can be appreciated that the order can be directed to the DLP who then routes the product directly to the patient's location such that the disclosed system obtains advantages associated with “just-in-time” delivery. If the product was routed directly to the patient, however, it may be a product that requires no interaction by the local provider such that the patient can utilize the product immediately, or where limited skill is required, the patient can assemble the product. Upon completion of delivery and installation of the product/service, the local provider reports completion of the transaction back to the system for further processing, as indicated in a function block 342.

Shipments are tracked utilizing conventional shippers, e.g., UPS, federal Express, etc., and who also provide such a tracking capability.

Note that at substantially all points of order processing, progress of the order is fed back into the system of the SBC such that any participating entity can access the system to ascertain order progress, and to retrieve other information for facilitating the disclosed system.

All purchasing is by the SBC via the linked system in accordance with a pre-established product and service cost and fee structure. For example, a suitable fee for services can be pre-established, and the amount of the service fee remitted to directly to the local provider (such fees and costs are pre-established in the preferred embodiment) when the service has been completed. Where products are involved, a range of prices may be provided. For example, there may be provided in a plan formulary five different types of wheelchairs from as many different manufacturers that a patient may be eligible to order. Based upon the patient requirements, a wheelchair can be ordered from any number of manufacturers.

Periodically (e.g., twice monthly), a “super bill” is presented to the Payor. Funds due are electronically routed through the subject linking system to various accounts of the corresponding entities. For example, fees are remitted to the PNM and the local provider for provider services, in accordance with the local provider's fee-for-services agreement, to manufacturers and/or a distribution partner (if the distribution partner holds procurement contracts with the manufacturer(s)) for products (e.g., cost of goods, picking, packing and delivery charges, etc.), and any compensation due to those who may have been referred and/or conducted business as part of the disclosed medical process. Occasionally and with pre-approval by the SBC, the local provider may purchase an item or utilize an item from its inventory to fulfill an order. In such event, the system will reimburse the local provider for the item rather than remitting payment to the manufacturer or the DLP.

Conventional systems parse out the responsibility for billing to a wide variety of participating entities such that, for example, each local dealer/local provider has to bill, collect, and pay the manufacturers on an individual basis. The disclosed linking system accommodates a single payment by the Payor, which is paid out to all participating entities electronically.

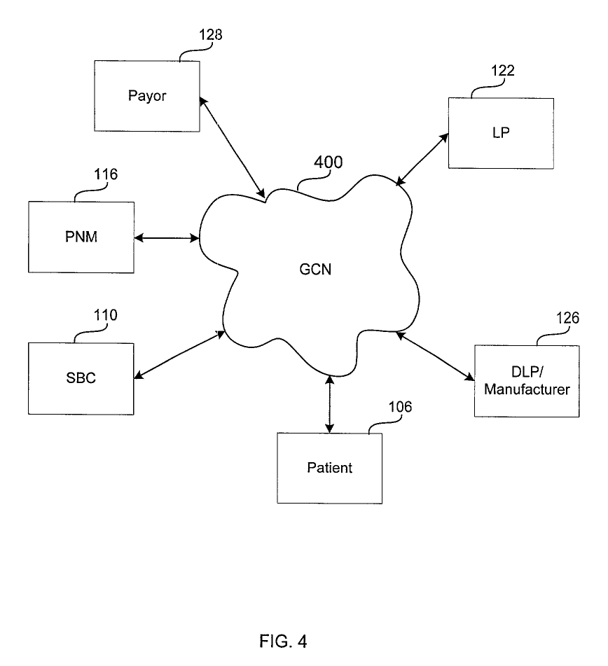

Referring now to FIG. 4, there is illustrated a system block diagram of the disclosed medical equipment and service reimbursement system. The system comprises a GCN 400 which provides the method of communication between many, if not all, of the illustrated entities, including the payor 128, the local provider 122, the PNM 116, the SBC 110, the patient 106, and the DLP/Manufacturer 126. The GCN 400, in this particular embodiment, may either be a packet-switched network (e.g., the Internet), a circuit-switched network (e.g., the public-switched telephone network—PSTN), or a combination thereof. It is preferable that the GCN 400 be a packet-switched network, however, and it can be appreciated that some of the entities may not have connectivity thereto, in which case, the PSTN can provide access. It is more likely that the patient 106 and/or local provider 122 may not be connected to a packet-switched GCN 400, in which case, use of the PSTN is required.

Where the GCN 400 is a packet-switched network, each entity is operable to connect to one or more websites which provide access to patient order information. Such an application to a packet-switched network offers the capability of global access from any node connected thereto. Access to the patient order information is restricted on a need-to-see basis, as indicated hereinabove, such that each of the various entities is provided access only to that information which is required for it to complete its function.

Information to the Payor and all members of the supply chain down to the patient is provided on a real-time basis from a linking database, and includes historical and active information. For example, the patient has the capability of tracking his or her order at any time, and to contact any party regarding refills, questions, issues, and problems. (The patient also experiences a much more rapid response time for installation and deliveries of products and services.) Since the type of information available to the various entities connected to the disclosed system is proprietary and confidential, security mechanisms for providing such access to the various levels of information are important. Therefore, only authorized users are allowed access to the various types of information stored in the databases of the system. For example, the patient may have access to detailed patient files associated with diagnosis, but not files associated with the distributor. The distributor will not have access to patient diagnosis files, as that information is not necessary for the distributor to perform its tasks. Each participant of the disclosed linking system has access to the various types of information on a “need-to-see” basis.

In summary, the disclosed end-to-end turnkey system provides a single outsource solution for every aspect of each transaction—from the point the patient is identified as being in need of a product and/or service in this category of health care, through the payment of the appropriate amounts to all participating parties. The disclosed health chain system removes inefficiencies present in conventional systems by reducing the number of returned items that previously resulted from inaccurate ordering or delays in fulfillment of orders. This reduction lowers the administrative overhead of such entities and increases the level of service being provided to patients. The disclosed novel health chain system introduces increased efficiency through the utilization of e-Commerce, and improves the overall profitability for each party who participates in a transaction, from the payor to the distributor to the manufacturer to the local provider. This is realized even though the cost to the payor is less, and the gross revenue to each participant in the supply chain may be reduced.

Although the preferred embodiment has been described in detail, it should be understood that various changes, substitutions and alterations can be made therein without departing from the spirit and scope of the invention as defined by the appended claims.

What is claimed is:

1. A method of provisioning and reimbursement for medical equipment and services, comprising the steps of:
generating a plan formulary in accordance with attributes of a health care payor;
subscribing one or more medical entities to process a patient order of a patient in accordance with said plan formulary, which said patient order comprises select ones of the medical equipment and services; and
communicating order information of said patient order to said one or more medical entities via a communication network to facilitate processing of said patient order.

2. The method of claim 1, wherein said communication network in the step of communicating is a global communication packet-switched network.

3. The method of claim 2, wherein said global communication packet-switched network is the Internet.

4. The method of claim 1, wherein said communication network in the step of communicating is a circuit-switched network.

5. The method of claim 1, wherein said plan formulary of said health care payor in the step of generating contains eligibility files which define eligibility of said select ones of the medical equipment and services of said patient order which are to be provided to said patient.

6. The method of claim 1, wherein a case manager reviews said eligibility of said select ones of the medical equipment and services of said patient order which are to be provided to said patient when predetermined criteria are met.

7. The method of claim 1, wherein said one or more medical entities process said patient order, in the step of subscribing, by a first delivery mode which delivers said select ones of the medical equipment and services directly to said patient, and a second delivery mode which delivers said select ones of the medical equipment and services first to a local provider, which said local provider then delivers said select ones of the medical equipment and services to said patient.

8. The method of claim 7, wherein each of the medical equipment and services are associated with either said first delivery mode or second delivery mode in accordance with associated delivery information contained in said plan formulary.

9. The method of claim 7, wherein said first delivery mode is associated with a distribution/logistics partner entity of said one or more medical entities in the step of subscribing which provides distribution logistics for delivery of said select ones of the medical equipment and services to said patient and said local provider.

10. The method of claim 7, wherein said second delivery mode is associated with a provider network manager entity of said one or more medical entities in the step of subscribing, which said provider network manager entity provides selection of an appropriate local provider for delivery thereto of said select ones of the medical equipment and services ordered by said patient.

11. The method of claim 1, wherein a system business center disposed on said communication network electronically places said patient order in response to receiving patient information from a local provider, said patient order placed electronically, in the step of communicating, to a manufacturer entity of said one or more medical entities disposed on said communication network, which said manufacturer entity manufactures medical equipment.

12. The method of claim 11, wherein said communication network is a global communication packet-switched network such that said a system business center performs an e-commerce transaction when placing said patient order to said manufacturing entity.

13. The method of claim 10, wherein said provider network manager receives said patient order via an electronic mail message transmitted over said communication network which is the Internet.

14. The method of claim 1, wherein said order information in the step of communicating is communicated to said one or more medical entities from a system business center disposed on said communication network.

15. The method of claim 14, wherein said system business center stores said order information of said patient order and all costs associated therewith.

16. The method of claim 15, wherein said costs are submitted to said health care payor via said communication network in the step of communicating on a periodic basis for reimbursement to said one or more medical entities which provide said select ones of the medical equipment and services.

17. The method of claim 16, wherein said communication network is the Internet.

18. The method of claim 16, wherein said reimbursement is via said system business center.

19. The method of claim 18, wherein said reimbursement is to a select one of said one or more medical entities who is a local provider.

20. The method of claim 18, wherein said reimbursement is to a select one of said one or more medical entities who is a provider network manager.

21. The method of claim 18, wherein said reimbursement is to a select one of said one or more medical entities who is a medical equipment manufacturer.

22. The method of claim 18, wherein said reimbursement is to a select one of said one or more medical entities who is a distribution/logistics partner.

23. The method of claim 1, wherein said order information of said patient order is accessible by said one or more medical entities via said communication network in the step of communicating.

24. A provisioning and reimbursement system for medical equipment and services, comprising:
a plan formulary generated in accordance with attributes of a health care payor;
one or more medical entities subscribed to process a patient order of a patient in accordance with said plan formulary, which said patient order comprises select ones of the medical equipment and services; and
order information of said patient order communicated to said one or more medical entities via a communication network to facilitate processing of said patient order.

25. The system of claim 24, wherein said communication network is a global communication packet-switched network.

26. The system of claim 25, wherein said global communication packet-switched network is the Internet.

27. The system of claim 24, wherein said communication network is a circuit-switched network.

28. The system of claim 24, wherein said plan formulary of said health care payor contains eligibility files which define eligibility of said select ones of the medical equipment and services of said patient order which are to be provided to said patient.

29. The system of claim 24, wherein a case manager reviews said eligibility of said select ones of the medical equipment and services of said patient order which are to be provided to said patient when predetermined criteria are met.

30. The system of claim 24, wherein said one or more medical entities process said patient order by a first delivery mode which delivers said select ones of the medical equipment and services directly to said patient, and a second delivery mode which delivers said select ones of the medical equipment and services first to a local provider, which said local provider then delivers said select ones of the medical equipment and services to said patient.

31. The system of claim 30, wherein each of the medical equipment and services is associated with either said first delivery mode or second delivery mode in accordance with associated delivery information contained in said plan formulary.

32. The system of claim 30, wherein said first delivery mode is associated with a distribution/logistics partner entity of said one or more medical entities which provides distribution logistics for delivery of said select ones of the medical equipment and services to said patient.

33. The system of claim 30, wherein said second delivery mode is associated with a provider network manager entity of said one or more medical entities, which said provider network manager entity provides selection of an appropriate local provider for delivery thereto of said select ones of the medical equipment and services ordered by said patient.

34. The system of claim 24, wherein a system business center disposed on said communication network electronically places said patient order in response to receiving patient information from a local provider, said patient order placed electronically to a manufacturer entity of said one or more medical entities disposed on said communication network, which said manufacturer entity manufactures medical equipment.

35. The system of claim 34, wherein said communication network is a global communication packet-switched network such that said system business center performs an e-commerce transaction when placing said patient order to said manufacturing entity.

36. The system of claim 33, wherein said provider network manager receives said patient order via an electronic mail message transmitted over said communication network which is the Internet.

37. The system of claim 24, wherein said order information is communicated to said one or more medical entities from a system business center disposed on said communication network.

38. The system of claim 37, wherein said system business center stores said order information of said patient order and all costs associated therewith.

39. The system of claim 38, wherein said costs are submitted to said health care payor via said communication network on a periodic basis for reimbursement to said one or more medical entities which provide said select ones of the medical equipment and services.

40. The system of claim 39, wherein said communication network is the Internet.

41. The system of claim 39, wherein said reimbursement is via said system business center.

42. The system of claim 41, wherein said reimbursement is to a select one of said one or more medical entities who is a local provider.

43. The system of claim 41, wherein said reimbursement is to a select one of said one or more medical entities who is a provider network manager.

44. The system of claim 41, wherein said reimbursement is to a select one of said one or more medical entities who is a medical equipment manufacturer.

45. The system of claim 41, wherein said reimbursement is to a select one of said one or more medical entities who is a distribution logistics partner.

46. The system of claim 24, wherein said order information of said patient order is accessible by said one or more medical entities via said communication network.

47. A method of medical equipment provisioning and reimbursement, comprising the steps of:
providing for interface and interaction with a payor to establish a plan formulary;
providing a data connection to a pre-selected plan;
establishing, via a pre-selected protocol, a connection to a payor-eligibility file to establish front-end eligibility;
communicating an order interface to allow for differentiation as to which items/products/services are direct to a consumer and which require a local provider;
directing an order, as it is placed, to an associated distribution/logistics partner;
receiving an electronic order that has been pre-authorized for patient eligibility and claims eligibility;
directing a received order to an associated case manager selected from an associated electronic catalogue;
rerouting a selected case manager back into the system to an associated distribution partner pre-selected in accordance with a specified plan formulary;
acknowledging an order to an associated local provider; and
accepting an order via said local provider that suitably selects from the routing an ordered item to a selected delivery site.

48. The method of claim 47, further comprising the step of periodically providing a super bill to said payor.

49. The method of claim 47, further comprising the step of selectively providing real-time access of selected historical and active information relating to the order through a linking database.

50. A method of medical equipment provisioning and reimbursement, comprising the steps of:
developing a plan formulary according to requirements of a payor;
interfacing said plan formulary with eligibility files of said payor via a global communication network to establish eligibility of products and services of a patient in accordance with said requirements of said plan formulary;
receiving a patient order of products and/or services via said global communication network;
determining eligibility of said patient and said patient order in accordance with said eligibility files and said requirements of said plan formulary;
ordering said patient order of product and/or services via a system business center disposed on said global communication network;
delivering said patient order to said patient via a local provider for a local provider fee; and
reimbursing said local provider fee to said local provider from said system business center in response to said system business center obtaining reimbursement of said local provider fee from said payor.
